(19) United States
(12) Patent Application Publication
(10) Pub. No.: US 2015/0002455 A1
(43) Pub. Date: Jan. 1, 2015

(54) CLOSE-RANGE SENSING METHOD AND DEVICE BASED ON CAPACITIVE TOUCH SCREEN AND COMMUNICATION TERMINAL

(71) Applicant: FocalTech Systems, Ltd., Grand Cayman, KY (US)

(72) Inventors: Jingkai ZHANG, Guangdong (CN); Weiping LIU, Guangdong (CN); Lianghua MO, Guangdong (CN)

(73) Assignee: FocalTech Systems, Ltd., Grand Cayman, KY (US)

(21) Appl. No.: 14/176,840

(22) Filed: Feb. 10, 2014

(30) Foreign Application Priority Data
Jun. 28, 2013 (CN) 201310269325.5

(51) Int. Cl. G06F 3/044

(52) U.S. Cl. CPC G06F 3/044
USPC 345/174

(57) ABSTRACT

A close-range sensing method based on a capacitive touch screen is provided, which includes: short-circuiting mutually N electrodes in the capacitive touch screen and connecting the N electrodes to a detecting circuit, where N is equal to or greater than 2; performing, by the detecting circuit, detection on the N electrodes; and calculating a distance from the capacitive touch screen to a human body or an object nearby based on a detection result. A corresponding device and a communication terminal are further provided in the embodiment of the present invention. The detecting data of the N electrodes can be accumulated to improve the accuracy of the detection. And, the detection noise is the same as the noise in the case where the detection is performed on any one electrode separately.

### CROSS-REFERENCE TO RELATED APPLICATION

The present application claims the priority to Chinese Patent Application No. 201310269325.5, entitled “CLOSE-RANGE SENSING METHOD AND DEVICE BASED ON CAPACITIVE TOUCH SCREEN AND COMMUNICATION TERMINAL”, filed with the Chinese State Intellectual Property Office on Jun. 28, 2013, the entire disclosure of which is incorporated herein by reference.

### BACKGROUND

1. Technical Field

The present disclosure relates to the technical field of communication technology, and in particular to a close-range sensing method and device based on a capacitive touch screen and a communication terminal.

2. Background of the Technology

Presently, an intelligent mobile phone with a touch screen probably has a problem of mis-operation of the system if the touch screen is not turned off, and the touch screen often becomes in touch with a human during a call. Therefore, the intelligent mobile phone with the touch screen generally has a function of close-range sensing, so as to turn off the touch screen or neglect the detection result of the touch screen when face or other parts of a human body is detected to be approaching a receiver or the touch screen of the mobile phone during a call, for avoiding the mis-operation caused by becoming in touch with the human body.

In the prior art, the above function of close-range sensing may be achieved in two ways. One is to mount a close-range sensor on the mobile phone, which is adapted to detect whether a human body or an object is approaching by using the infrared light and lock the touch screen when a human body is within a certain range. The other is to achieve the function of close-range sensing by using a touch screen.

Referring to FIG. 1, when some part of the human, such as the face, approaches the touch screen, multiple capacitances (C1 to Cn) is formed between the human face and multiple electrodes (S1 to Sn) in the touch screen. The distance from the human body to the touch screen can be detected by detecting these capacitances (C1 to Cn). However, because the human body does not touch with the touch screen, these capacitances (C1 to Cn) are rather small, which are one order of magnitude smaller than the capacitance detected when the human body touches with the touch screen. Thus, the measuring result is not accurate enough, resulting in relatively low reliability.

To improve the accuracy of the detection, it is a common way to accumulate data (D1 to Dn) of the detection results of the multiple electrodes in the whole or a specific area of the touch screen, such as the first half of the touch screen, and make a judgment based on the accumulated value. If the accumulated value is equal to or greater than a specific threshold, it is determined that the human body approaches the touch screen. The amount of the detection data is increased by multiple times by using the accumulated value, thereby the accuracy of the detection is improved, but the noise is also enhanced.

The detection data have relativity, the amplitudes of the detection data are accumulated directly, the accumulated amplitude of the detection data is assumed to be: D1+D2+ . . . +Dn; the noises are respectively N1 to Nn, which are random and have no relativity, the accumulated amplitude of the noises is \sqrt{N₁²+N₂²+ . . . +Nₙ²}, which is greater than any one of N1 to Nn, and then the amplitude of the noise is increased.

It can be seen that with the method in which the detection results of multiple electrodes are accumulated, the accuracy of the detection is improved, but the noise is also enhanced, thus the signal to noise ratio is not high enough, resulting in less effective detecting distance. In order to detect the approach of the human to the touch screen, it needs to further improve the effective detecting distance of the touch screen.

### SUMMARY

In view of this, a close-range sensing method and device based on a capacitive touch screen and a communication terminal are provided according to embodiments of the invention, for improving the effective detecting distance of the touch screen.

According to an embodiment of the invention, it is provided a close-range sensing method based on a capacitive touch screen, which includes: short-circuiting mutually N electrodes in the capacitive touch screen and connecting the N electrodes to a detecting circuit, where N is equal to or greater than 2; performing, by the detecting circuit, detection on the N electrodes; and calculating a distance from the capacitive touch screen to a human body or an object nearby based on a detection result.

According to an embodiment of the invention, it is further provided a close-range sensing device based on a capacitive touch screen, which includes: a connecting module, adapted to short-circuit mutually N electrodes in the capacitive touch screen and connect the N electrodes to a detecting circuit, where N is equal to or greater than 2; a detecting module, adapted to perform detection on the N electrodes by the detecting circuit; and a calculating module, adapted to calculate a distance from the capacitive touch screen to a human body or an object nearby based on a detection result from the detecting module.

According to an embodiment of the invention, it is provided a communication terminal, which includes: a display screen, a capacitive touch screen attached onto the display screen, a detecting circuit connected to the capacitive touch screen, and a processor, herein the processor is adapted to control N electrodes in the capacitive touch screen to be short-circuited mutually and connected to the detecting circuit in the case that the communication terminal is detected to be in a calling state, where N is equal to or greater than 2; the detecting circuit is adapted to perform detection on the N electrodes; and the processor is further adapted to calculate a distance from the capacitive touch screen to a human body or an object nearby based on a detection result from the detecting circuit.

In the embodiment of the present invention, the following technical solution is adopted: the N electrodes in the capacitive touch screen are short-circuited mutually and connected to the detecting circuit to detect the distance. The detecting data of the N electrodes are accumulated to improve the accuracy of the detection. And, the detection noise is the same as the noise in the case where the detection is performed on any one electrode separately. As compared with the prior art, the noise is reduced, the signal to noise ratio is improved, and thus the effective detected distance of the capacitive touch screen is extended.

### BRIEF DESCRIPTION OF THE DRAWINGS

FIG. 1 is a schematic diagram showing that multiple capacitances are formed between an approaching human body and multiple electrodes in a touch screen;

FIG. 2 is a flow chart of a close-range sensing method based on a capacitive touch screen according to an embodiment of the present invention;

FIG. 3 is a structural diagram of a close-range sensing device based on a capacitive touch screen according to an embodiment of the present invention;

FIG. 4 is a schematic diagram of a close-range sensing device based on a capacitive touch screen according to an embodiment of the present invention; and

FIG. 5 is a schematic diagram of a communication terminal according to an embodiment of the present invention.

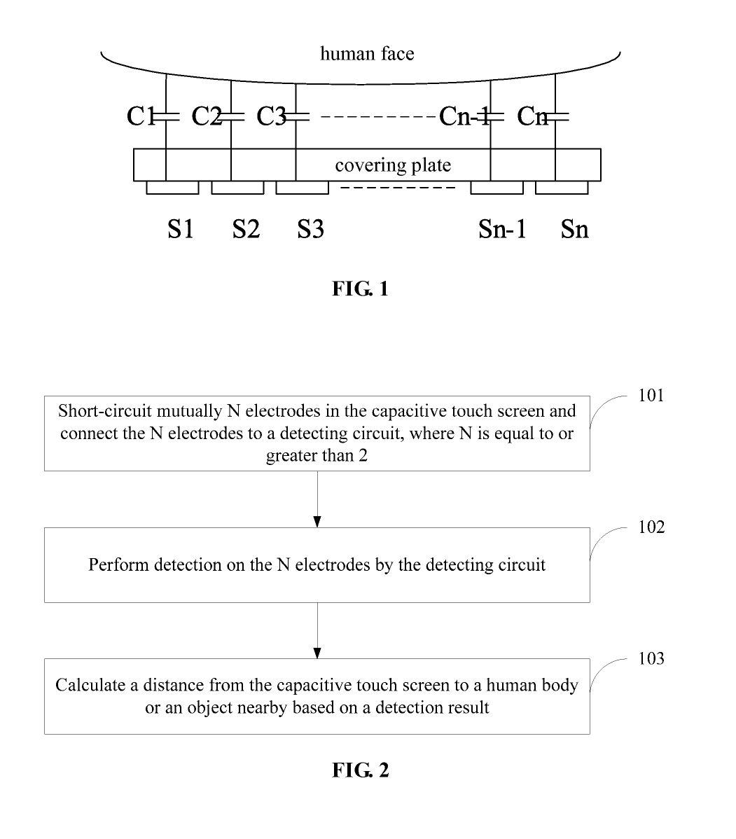

### DETAILED DESCRIPTION

According to an embodiment of the present invention, it is provided a close-range sensing method based on a capacitive touch screen, in which the signal to noise ratio of the detection data can be improved when the distance between a human body and a capacitive touch screen is small by using the capacitive touch screen, and thus the effective detecting distance of the capacitive touch screen is improved. Accordingly, a corresponding device and a communication terminal are provided in an embodiment of the present invention. The detailed descriptions are given below.

### First Embodiment

Referring to FIG. 2, a close-range sensing method based on a capacitive touch screen is provided according to the embodiment of the present invention, and the method includes the following step 101 to step 103.

Step 101, short-circuiting mutually N electrodes in the capacitive touch screen and connecting the N electrodes to a detecting circuit, where N is equal to or greater than 2.

In the prior art, the N electrodes in the capacitive touch screen of a communication terminal are isolated from each other, detection is performed on each electrode respectively by using one or more detecting circuits, each detecting circuit detects only one electrode at a time, and the detection data of the electrodes are accumulated finally.

In the embodiment of the present invention, the N electrodes in a certain area on the capacitive touch screen, such as the area corresponding to the part of the approaching human body, are short-circuited mutually, and are connected to the same detecting circuit. As shown in FIG. 3, the N electrodes, i.e., S1 to Sn, may be connected to an input of the detecting circuit via a conductive wire respectively, so as to achieve the short-circuit of the N electrodes and the connection of the N electrodes with the detection circuit, where N is equal to or greater than 2.

Optionally, as shown in FIG. 3, a switch may be provided in a connecting circuit between each electrode and the detecting circuit, i.e., the N electrodes are connected to the input of the detecting circuit via N switches respectively. Thus, by closing the N switches, the electrodes can be controlled to be connected to the detecting circuit and short-circuited mutually, for detecting; and when the N switches are opened, other operation may be performed. These switches may be controlled by software or hardware, and finally may be controlled by a controller of the communication terminal.

Step 102, detecting the N electrodes by the detecting circuit.

Because the N electrodes are all connected to the detecting circuit, the detection data of the N electrodes may be obtained at the same time. It is assumed that the capacitances between the N electrodes and the part of the approaching human body are respectively C1 to Cn, the total capacitance is C=C1+C2+ . . . +Cn. It is assumed that the detection data in this step is D=D1+D2+ . . . +Dn; where D1 to Dn are respectively the detection data obtained when the detection is performed on the N electrodes, and D is the accumulated sum. It can be seen that in this embodiment, the obtained detection data has the same effect as that in the prior art in which the detection is performed on each electrode respectively and then the data are accumulated.

However, it is to be noted that the noise of the detection data in this embodiment is smaller than that in the prior art. It is assumed that the detection is performed on the N electrode by using one detecting circuit in the prior art, the noise of the N detection data are respectively marked as M1 to Mn, the total noise is \sqrt{M₁²+M₂²+ . . . +Mₙ²}=\sqrt{n}*M₁, because N1=M2= . . . =Mn. In the technical solution according to the embodiment of the present invention, the detection result is obtained by only one detecting operation of the detecting circuit, and the noise of the detection data is M1. It can be seen that the noise of the final detection data in this embodiment of the present invention is less than the noise of the final detection data in the prior art by \sqrt{n} times.

In the prior art, if the detection is performed on the N electrodes by using N different detecting circuits, the noise M1 to Mn of the N detection data are not equal, and the noise of the detection \sqrt{M₁²+M₂²+ . . . +Mₙ²₁} is no longer equal to \sqrt{n}*M₁, but still close to \sqrt{n}*M₁. It is assumed that in this embodiment, the detection is performed on the N electrodes that are short-circuited at the same time by using only one of the N detecting circuits, and the noise of the detection data is still one of M1 to Mn, which is far less than the noise \sqrt{M₁²+M₂²+ . . . +Mₙ²₁} of the detection data in the prior art by nearly \sqrt{n} times.

Step 103, calculating a distance from the capacitive touch screen to a human body or an object nearby based on a detection result.

In this step, the distance from the capacitive touch screen to a human body or an object nearby is calculated based on a detection data obtained when the detection is performed on the electrode. This calculation method is the same as that in the prior art, and is not described in detail here. It is to be noted that as compared with the prior art, the amplitude of the detection data in this embodiment is the same, and the noise is reduced by \sqrt{n} times, that is, the signal to noise ratio is improved by \sqrt{n} times. Thus, in this embodiment of the present invention, the accuracy of the detection is higher, the detected distance is longer, and the effective detected distance may even be \sqrt{n} times as that in the prior art.

Optionally, after step 103, the method may further include: turning off the capacitive touch screen in the case that the detected distance is equal to or greater than a preset threshold.

In summary, a close-range sensing method based on a capacitive touch screen is provided in the embodiment of the present invention, in which the N electrodes in the capacitive touch screen are short-circuited mutually and connected to the detecting circuit, for detecting the distance. The detecting data of the N electrodes are accumulated to improve the accuracy of the detection. And, the detection noise is the same as the noise in the case where the detection is performed on any one electrode separately. As compared with the prior art, the noise is reduced, the signal to noise ratio is improved, and thus the effective detected distance of the capacitive touch screen is extended, so that a human body or an object approaching the capacitive touch screen can be detected at a farther position.

### Second Embodiment

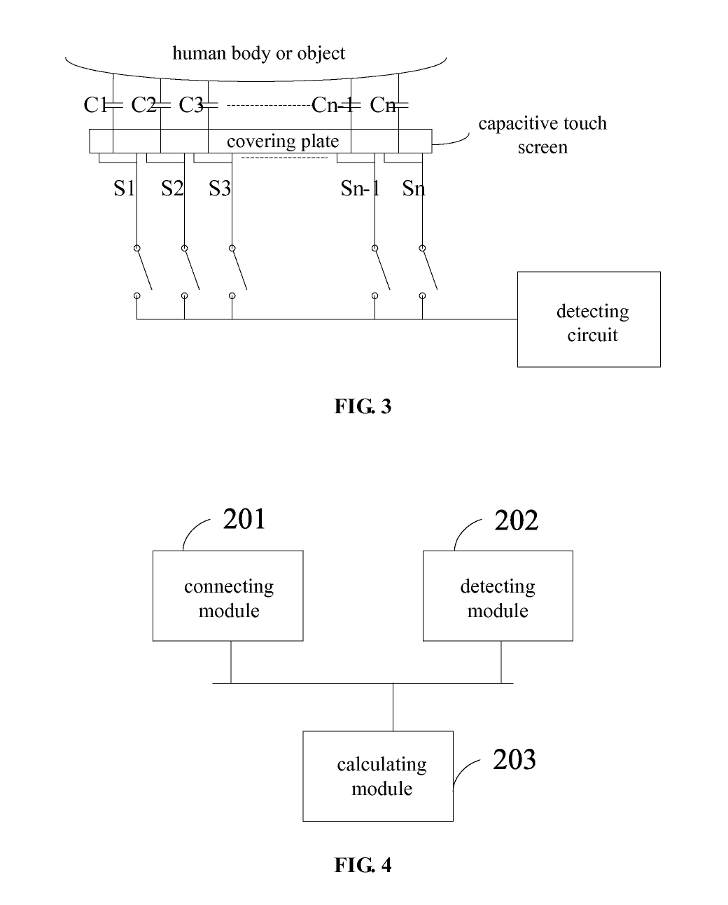

Referring to FIG. 4, according to an embodiment of the present invention, it is provided a close-range sensing device based on a capacitive touch screen, which includes:

a connecting module 201, adapted to short-circuit mutually N electrodes in the capacitive touch screen and connect the N electrodes to a detecting circuit, where N is equal to or greater than 2;

a detecting module 202, adapted to perform detection on the N electrodes by the detecting circuit; and

a calculating module 203, adapted to calculate a distance from the capacitive touch screen to a human body or an object nearby based on a detection result from the detecting module.

Optionally, the device further includes:

a turning-off module, adapted to turn off the capacitive touch screen when the distance calculated by the calculating module is equal to or greater than a preset threshold.

In an embodiment, the N electrodes are connected to an input of the detecting circuit via N switches respectively; and the connecting module is adapted to close the N switches so that the N electrodes in the capacitive touch screen are short-circuited mutually and are connected to the detecting circuit.

For more detailed description, reference can be made to the description in the first embodiment.

In summary, a close-range sensing device based on a capacitive touch screen is provided in the embodiment of the present invention, in which the N electrodes in the capacitive touch screen are short-circuited mutually and connected to the detecting circuit, for detecting the distance. The detecting data of the N electrodes are accumulated to improve the accuracy of the detection. And, the detection noise is the same as the noise in the case where the detection is performed on any one electrode separately. As compared with the prior art, the noise is reduced, the signal to noise ratio is improved, and thus the effective detected distance of the capacitive touch screen is extended, so that a human body or an object approaching the capacitive touch screen can be detected at a farther position.

### Third Embodiment

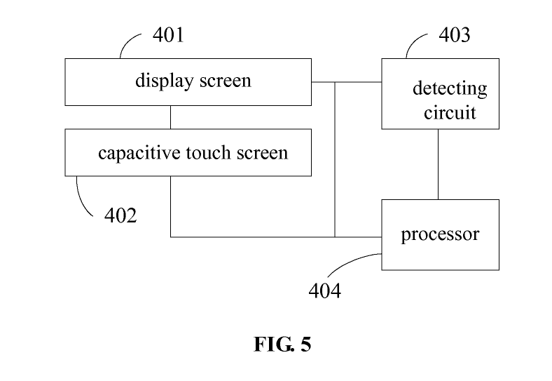

Referring to FIG. 5, according to an embodiment of the present invention, it is provided a communication terminal, which includes: a display screen 401, a capacitive touch screen 402 attached onto the display screen, a detecting circuit 403 connected to the capacitive touch screen 402, and a processor 404, herein,

the processor 404 is adapted to control N electrodes in the capacitive touch screen to be short-circuited mutually and connected to the detecting circuit in the case that the communication terminal is detected to be in a calling state, where N is equal to or greater than 2;

the detecting circuit 403 is adapted to perform detection on the N electrodes; and

the processor 404 is further adapted to calculate a distance from the capacitive touch screen to a human body or an object nearby based on a detection result from the detecting circuit.

Optionally, the processor 404 is further adapted to turn off the capacitive touch screen in the case that the distance is equal to or greater than a preset threshold.

In an embodiment, the N electrodes are connected to an input of the detecting circuit via N switches respectively; and the processor 404 is adapted to control the N switches to be closed in the case that the communication terminal is detected to be in the calling state.

The communication terminal may be a common device, such as a mobile phone, a tablet computer or a laptop computer, but not limited to these, and may also be various other devices with capacitive touch screen, such as a paging communication device or a wearable communication device. Any communication terminal which has a capacitive touch screen and adopts the various technical solutions disclosed herein all fall within the scope of protection of the present invention.

In summary, a communication terminal is provided in the embodiment of the present invention, in which the N electrodes in the capacitive touch screen are short-circuited mutually and connected to the detecting circuit, for detecting the distance. The detecting data of the N electrodes are accumulated to improve the accuracy of the detection. And, the detection noise is the same as the noise in the case where the detection is performed on any one electrode separately. As compared with the prior art, the noise is reduced, the signal to noise ratio is improved, and thus the effective detected distance of the capacitive touch screen is extended, so that a human body or an object approaching the capacitive touch screen can be detected at a farther position.

It can be understood by those skilled in the art that all or some of the steps in the various methods according to the above embodiments can be implemented by hardware, and can also be implemented by hardware related to program or instruction, which is stored in a computer readable storage medium which may be a read-only memory, a random access memory, a magnetic disk, an optical disk or the like.

The close-range sensing method and device based on a capacitive touch screen and the communication terminal according to the embodiments of the present invention have been described in detail above. However, the descriptions of the above embodiments are only used to help to understand the method of the disclosure and the core idea thereof, but should not be interpreted as to limiting the scope of the disclosure. May variations and alternations may be made by those skilled in the art without deviating from the technical scope of the present disclosure, which variations and alternations all fall within the scope of protection of the principles disclosed herein.

What is claim is:

1. A close-range sensing method based on a capacitive touch screen, comprising:
short-circuiting mutually N electrodes in the capacitive touch screen and connecting the N electrodes to a detecting circuit, wherein N is equal to or greater than 2;
performing, by the detecting circuit, detection on the N electrodes; and
calculating a distance from the capacitive touch screen to a human body or an object nearby based on a detection result.

2. The method according to claim 1, further comprising:
turning off the capacitive touch screen in the case that the distance is equal to or greater than a preset threshold.

3. The method according to claim 1, wherein
the N electrodes are connected to an input of the detecting circuit via N switches respectively; and
the short-circuiting mutually N electrodes in the capacitive touch screen and connecting the N electrodes to a detecting circuit comprises:
closing the N switches to facilitate the N electrodes in the capacitive touch screen short-circuiting mutually and connecting to the detecting circuit.

4. A close-range sensing device based on a capacitive touch screen, comprising:
a connecting module, adapted to short-circuit mutually N electrodes in the capacitive touch screen and connect the N electrodes to a detecting circuit, wherein N is equal to or greater than 2;
a detecting module, adapted to perform detection on the N electrodes by the detecting circuit; and
a calculating module, adapted to calculate a distance from the capacitive touch screen to a human body or an object nearby based on a detection result from the detecting module.

5. The device according to claim 4, further comprising:
a turning-off module, adapted to turn off the capacitive touch screen in the case that the distance calculated by the calculating module is equal to or greater than a preset threshold.

6. The device according to claim 4, wherein
the N electrodes are connected to an input of the detecting circuit via N switches respectively; and
the connecting module is adapted to close the N switches to facilitate the N electrodes in the capacitive touch screen short-circuiting mutually and connecting to the detecting circuit.

7. A communication terminal, comprising: a display screen, a capacitive touch screen attached onto the display screen, a detecting circuit connected to the capacitive touch screen, and a processor, wherein
the processor is adapted to control N electrodes in the capacitive touch screen to be short-circuited mutually and connected to the detecting circuit in the case that the communication terminal is detected to be in a calling state, wherein N is equal to or greater than 2;
the detecting circuit is adapted to perform detection on the N electrodes; and
the processor is further adapted to calculate a distance from the capacitive touch screen to a human body or an object nearby based on a detection result from the detecting circuit.

8. The communication terminal according to claim 7, wherein
the processor is further adapted to turn off the capacitive touch screen in the case that the distance is equal to or greater than a preset threshold.

9. The communication terminal according to claim 7, wherein
the N electrodes are connected to an input of the detecting circuit via N switches respectively; and
the processor is adapted to control the N switches to be closed in the case that the communication terminal is detected to be in the calling state.

10. The communication terminal according to claim 7, wherein
the communication terminal is a mobile phone, a tablet computer or a laptop computer.

11. The communication terminal according to claim 8, wherein
the communication terminal is a mobile phone, a tablet computer or a laptop computer.

12. The communication terminal according to claim 9, wherein
the communication terminal is a mobile phone, a tablet computer or a laptop computer.
